(19) United States
(12) Patent Application Publication
(10) Pub. No.: US 2015/0077998 A1
(43) Pub. Date: Mar. 19, 2015

(54) FLEXIBLE LED LIGHT STRING

(71) Applicant: GEMMY INDUSTRIES CORPORATION, Coppell, TX (US)

(72) Inventor: Cheng-Chun ZHANG, Shenzhen City (CN)

(73) Assignee: GEMMY INDUSTRIES CORPORATION, Coppell, TX (US)

(21) Appl. No.: 14/027,913

(22) Filed: Sep. 16, 2013

(51) Int. Cl. F21V 23/06; F21V 31/00; F21K 99/00

(52) U.S. Cl. CPC F21V 23/06; F21K 9/30; F21V 31/00; F21V 31/005
USPC 362/249.04

(57) ABSTRACT

A flexible LED light string includes a power control assembly and at least one light strip, wherein the power control assembly uses a main connector for screwing to a front connector of the at least one light strip. The strip further has a rear connector for screwing to another light strip sequentially connected. By screwing the rear and front connectors of two adjacent light strips, forming a decorative light string with a required length is relatively easy and fast. Waterproof elements may be provided between two assembled connectors to improve sealing effect.

### BACKGROUND OF THE INVENTION

1. Field of the Invention

The present invention relates to a flexible LED light string, and more particularly to a flexible LED light string that can be configured to any particular shape as required and can be easily and conveniently connected to other light strings of the same configuration.

2. Description of the Prior Art

An LED-based decorative light string is commonly seen in the market nowadays. Particularly, a flexible LED light string made of soft material is very preferable to consumers because it can be configured to any particular shape or wound around objects for decoration purposes.

Most of the manufacturers of the flexible LED light strings will provide multiple types of products with different fixed lengths. The fixed-length LED light string may not be practical for all occasions or purposes. Thus, a new type of LED light string connectable in series is launched for consumers. The consumers can buy multiple LED light strings and form a lengthened light string by sequentially connecting these light strings.

However, linking structures of the connectable LED light strings are inconvenient to users for quickly connecting the LED light strings.

The present invention thus develops a novel flexible LED light string to mitigate or solve the problems mentioned above.

### SUMMARY OF THE INVENTION

The main objective of the present invention is to provide a flexible LED light string that allows users to connect multiple light strips to form a decorative light string without using any hand tools.

The flexible LED light string comprises a power control assembly and at least one light strip. The power control assembly comprises a plug, a power converter connected to the plug and outputting a DC voltage; and a main connector connected to the power converter for transmitting the DC voltage. The at least one light strip each comprises a body, a front connector assembled to a first end of the body and detachably screwed to the main connector of the power control assembly, and a rear connector assembled to a second end of the body for screwing to another subsequent light strip.

According to the present invention, the front connector of the at least one light strip is screwed to the main connector of the power control assembly for receiving the DC voltage. The rear connector of the at least one light strip is proved for screwing to another light strip sequentially connected, whereby a user can easily form a decorative light string of a required length.

Other objectives, advantages and novel features of the invention will become more apparent from the following detailed description when taken in conjunction with the accompanying drawings.

### BRIEF DESCRIPTION OF THE DRAWINGS

FIG. 1 shows an AC flexible LED light string with a control box of the present invention;

FIG. 2 is an exploded perspective view of the AC flexible LED light string of FIG. 1;

FIG. 3 is a cross-sectional view of a male connector assembled with a female connector of the flexible LED light string of the present invention;

FIG. 4 shows an AC flexible LED light string without a control box of the present invention;

FIG. 5 shows a DC flexible LED light string with a control box of the present invention;

FIG. 6 shows a DC flexible LED light string without a control box of the present invention;

FIG. 7 shows a circuit diagram of the DC flexible LED light string operated in a normally-lighting mode of the present invention;

FIG. 8 shows a circuit diagram of the AC flexible LED light string operated in a normally-lighting mode of the present invention; and

FIG. 9 shows a circuit diagram of the AC flexible LED light string operated in a self-flashing mode of the present invention.

### DETAILED DESCRIPTION OF THE PREFERRED EMBODIMENTS

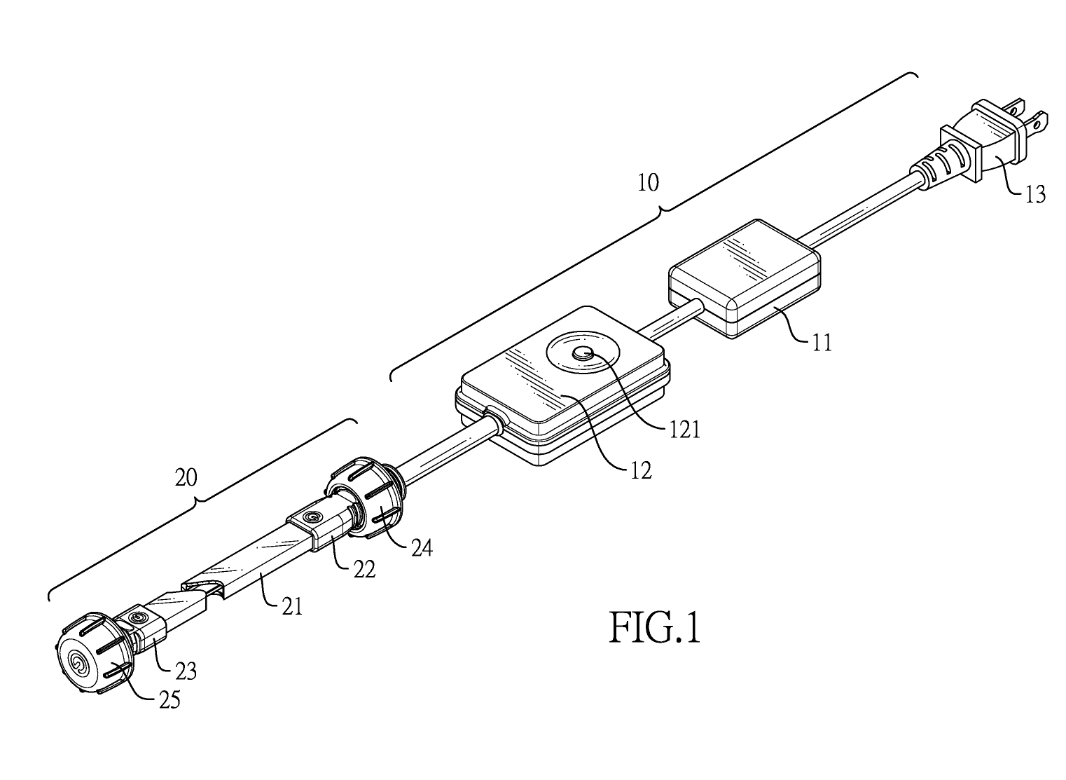

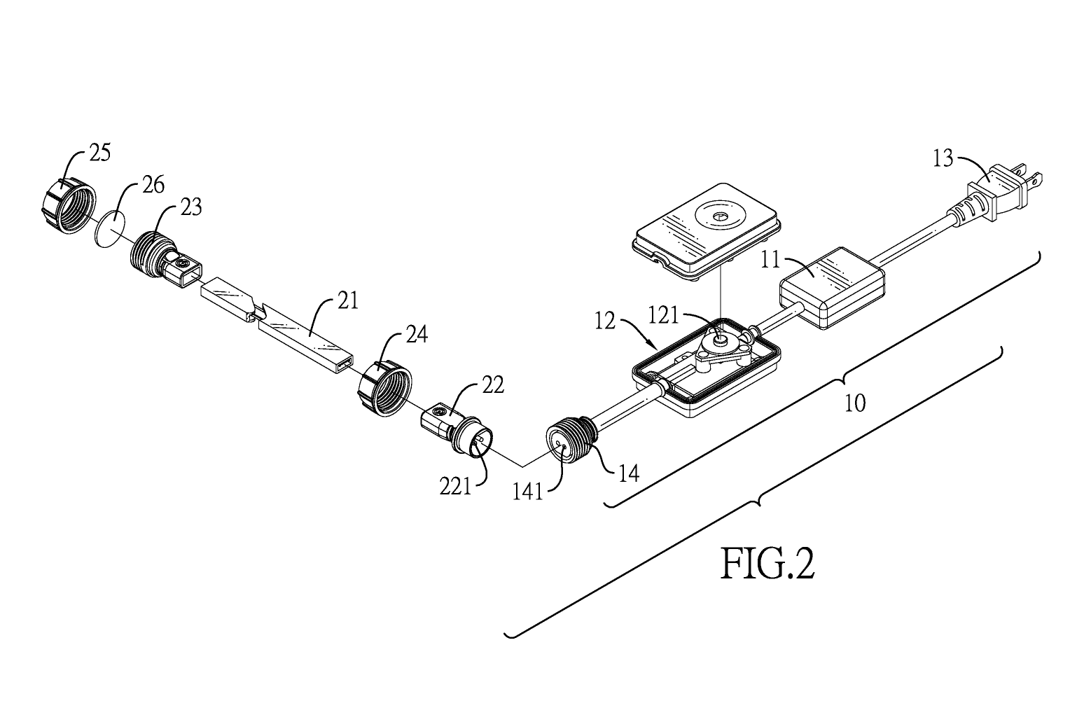

With reference to FIGS. 1 and 2, a first embodiment of a flexible LED light string of the present invention comprises a power control assembly 10 and at least one light strip 20.

The power control assembly 10 includes a power converter 11, a control box 12, a plug 13 and a main connector 14. The power converter 11 converts an AC voltage received through the plug 13 to a DC voltage for driving LEDs. The converted DC voltage may be either a half wave DC voltage or a full wave DC voltage. The control box 12 is connected between the power converter 11 and the main connector 14.

The control box 12 may optionally include at least one control button 121. The control box 12 without the control button 121 may have a pre-stored control program for generating control commands to drive the at least one light strip 20 and generate different default lighting effects. Alternatively, the control box 12 with the control button 121 allows a user to select and change lighting effects by operating the control button 121. The control box 12 may further include a wireless receiver for receiving an external control signal output from an external lighting controller. According to the external control signal received, the control box 12 also generates the control commands to drive the at least one light strip 20 for having the lighting effects by demand.

The control box 12 comprises a top shell having a top opening, a bottom shell having a bottom opening and assembled to the top shell, a control circuit board mounted between the top shell and the bottom shell. A waterproof rubber ring may be mounted around edges of the top opening and the bottom opening to improve waterproof effect.

The main connector 14 is connected to an output of the control box 12 and is provided to connect to the at least one light strip 20. The DC voltage and the control commands from the control box 12 are transmitted to the at least one light strip 20 through the main connector 14. The main connector 14 has a threaded outer surface and two terminal holes 141.

The at least one light strip 20 each comprises a body 21 having two ends, a front connector 22 and a rear connector 23. The body 21 has a flexible circuit board, multiple LEDs mounted on the flexible circuit board, and a light-pervious protection tube mounted around the flexible circuit board.

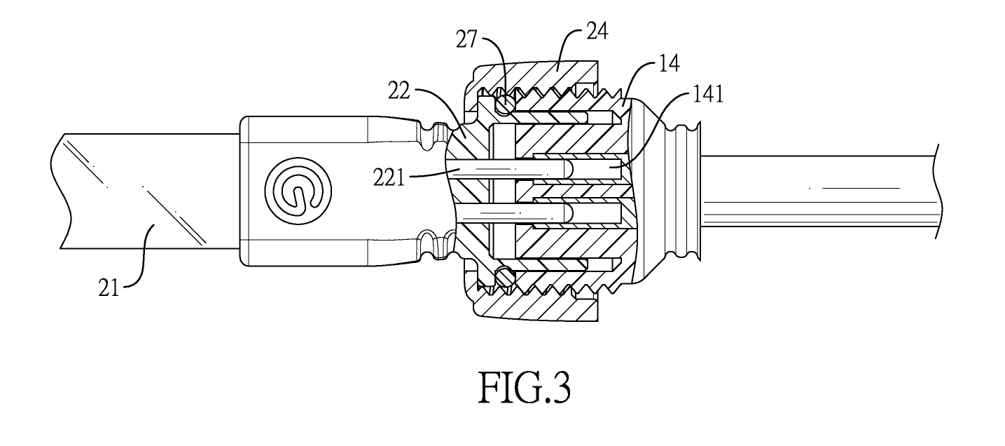

The front connector 22 has a first end and a second end. With further reference to FIG. 3, the first end of the front connector 22 is assembled to one end of the body 21, and the second end of the front connector 22 is configured as a male connector with two signal terminals 221 for inserting into and being electrically connected the terminal holes 141. After the insertion of the signal terminals 221 to the terminal holes 141, a fixing nut 24 mounted around the front connector 22 can be correspondingly screwed with the main connector 14 by a threaded inner surface formed in the fixing nut 24 to enhance the connection between the body 21 and the main connector 14. A waterproof washer 27 may be provided between the front connector 22 and the main connector 14 to increase sealing effect.

The rear connector 23 is assembled to the other end of the body 21 for connecting to another light strip 20, thereby forming a complete light string with a required length by the multiple light strips 20 connected sequentially. In this embodiment, the rear connector 23 has a configuration the same as the main connector 14. The rear connector 23 has a first end and a second end, wherein the first end is assembled to the other end of the body 21. The second end of the rear connector 23 is configured as a female connector with a threaded outer surface and two terminal holes for receiving the signal terminals 221 of a subsequently connected light strip 20.

When multiple light strips 20 are connected in series, a sealing lid 25 can be assembled to the rear connector 23 of the last light strip 20 for waterproof purpose. The sealing lid 25 has a threaded inner surface for correspondingly screwing with the threaded outer surface of the rear connector 23. A waterproof washer 26 may be inserted between the sealing lid 25 and the rear connector 23.

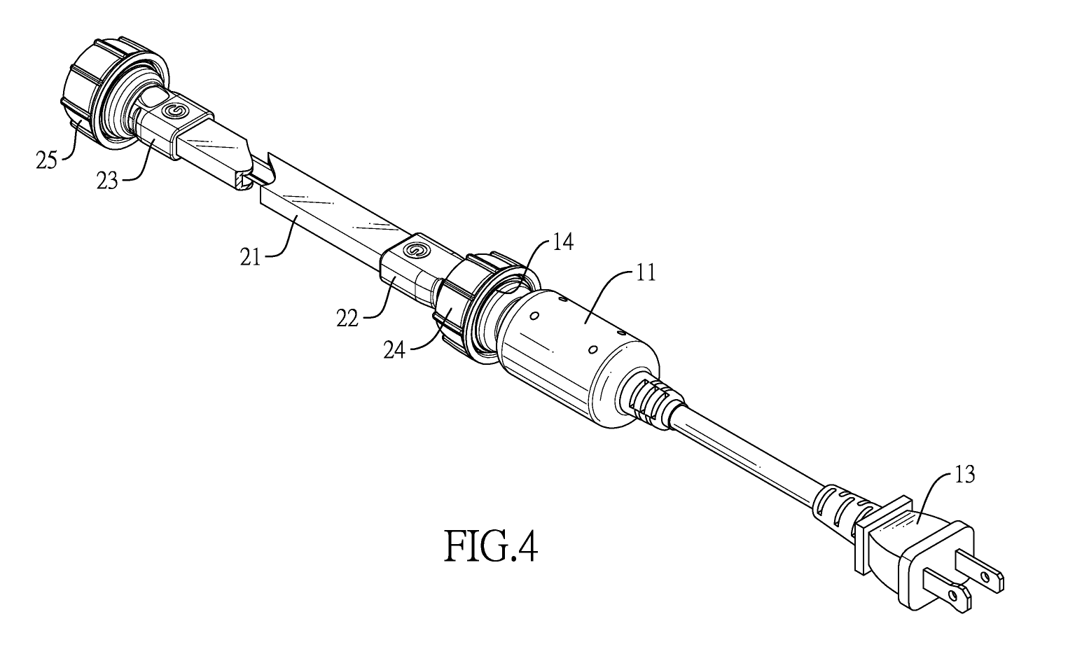

With reference to FIG. 4, the second preferred embodiment is configured as an AC flexible LED light string without the control box. The power converter 11 and the main connector 14 are formed integrally by injection modeling process. The power control assembly 10 does not need a control box. The power converter 11 converts the AC voltage to the DC voltage for driving the LEDs in the at least one flexible light strip 20.

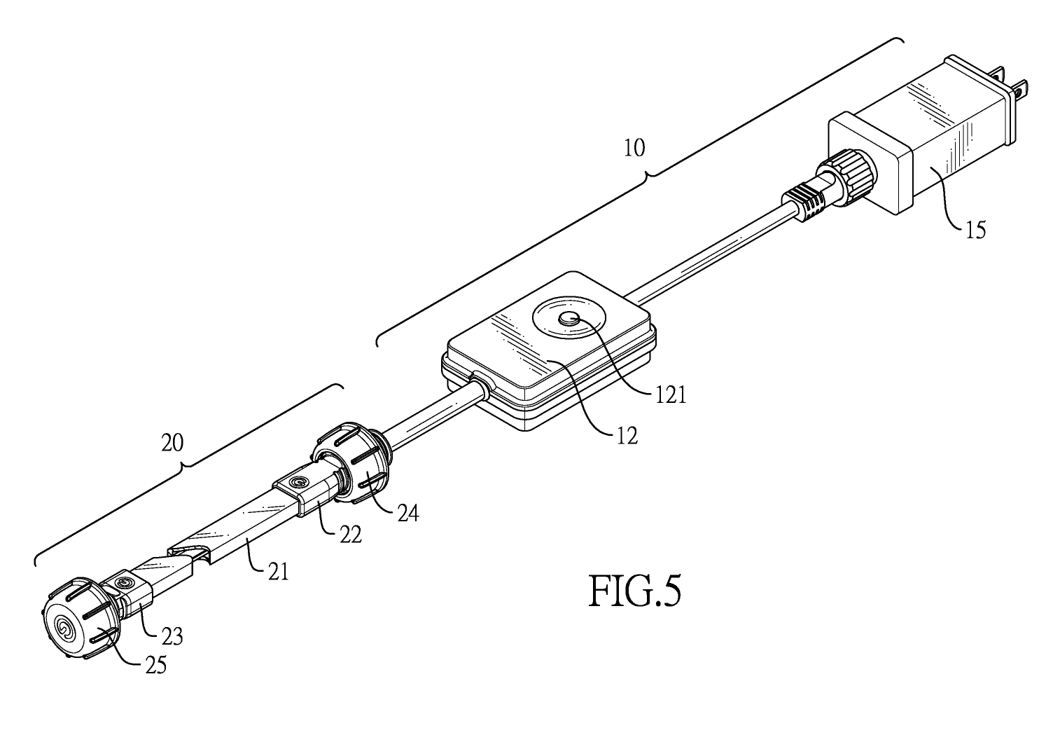

With reference to FIG. 5, the third preferred embodiment is configured as a DC flexible LED light string with a control box. The power converter 11 and the plug 13 are integrated as a DC power plug 15. A voltage output from the DC power plug 15 is a DC voltage capable of driving the LEDs.

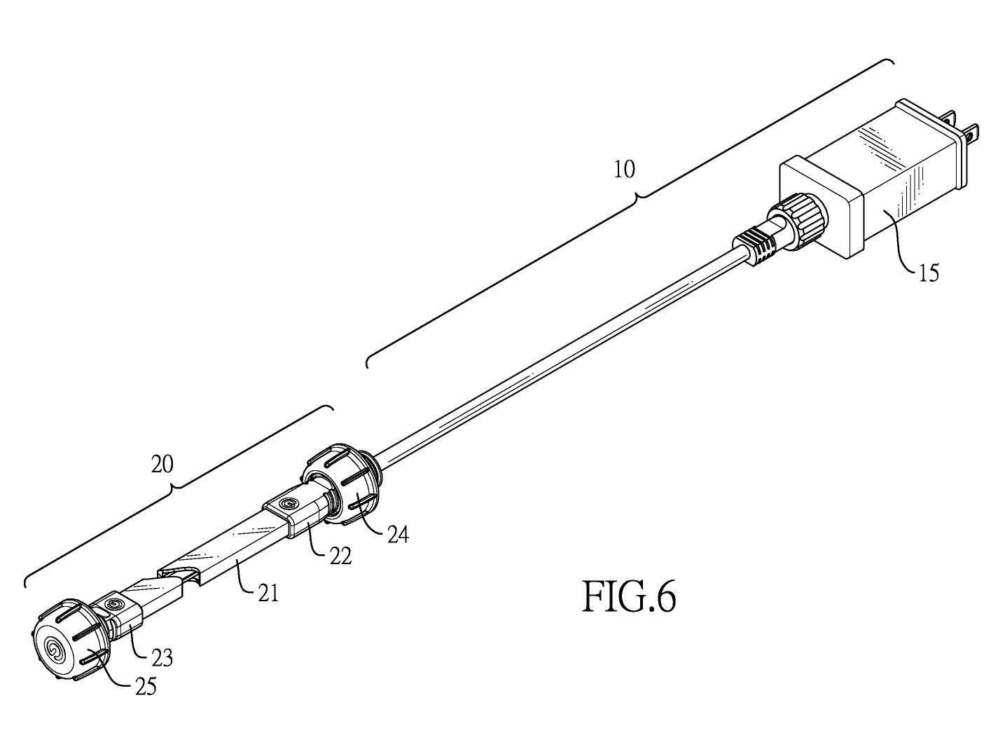

With reference to FIG. 6, the fourth preferred embodiment is configured as a DC flexible LED light string without a control box. The power converter 11 and the plug 13 are integrated as a DC power plug 15. A voltage output from the DC power plug 15 is a DC voltage capable of driving the LEDs.

The at least one light strip 20 can work in different operating modes such as a normally-lighting mode, a self-flashing mode, a self-color-changing mode or a controllable lighting mode. The normally-lighting mode, the self-color-changing mode, self-flashing mode are preferably implemented by the embodiments of FIGS. 4 and 6. The controlled lighting mode is preferably implemented by the embodiments of FIGS. 1, 2 and 5. The operating modes are introduced hereinafter.

Normally-lighting mode: The body 21 uses the LEDs of the same color or different colors as lighting elements and all the LEDs are always turned on.

Self-color-changing mode: Each of the LEDs mounted on the body is composed of a control chip and multiple LED chips of primary colors R, G and B, wherein each LED chip has 256 illumination gray levels. The control chip automatically controls the LED chips to generate and mix primary colors to obtain various lighting colors.

Self-flashing mode: Each of the LEDs mounted on the body is composed of a control chip and multiple LED chips of the same color or different primary colors R, G and B. The control chip will automatically control the LEDs to be alternately turned on or off for a pre-default time. Therefore, the LEDs will generate flashing or dynamic effects.

Controllable lighting mode: This mode is similar to the normally-lighting mode, wherein the multiple LEDs on the body 21 are divided into multiple groups. The control box 21 outputs control commands to turn on or off each group.

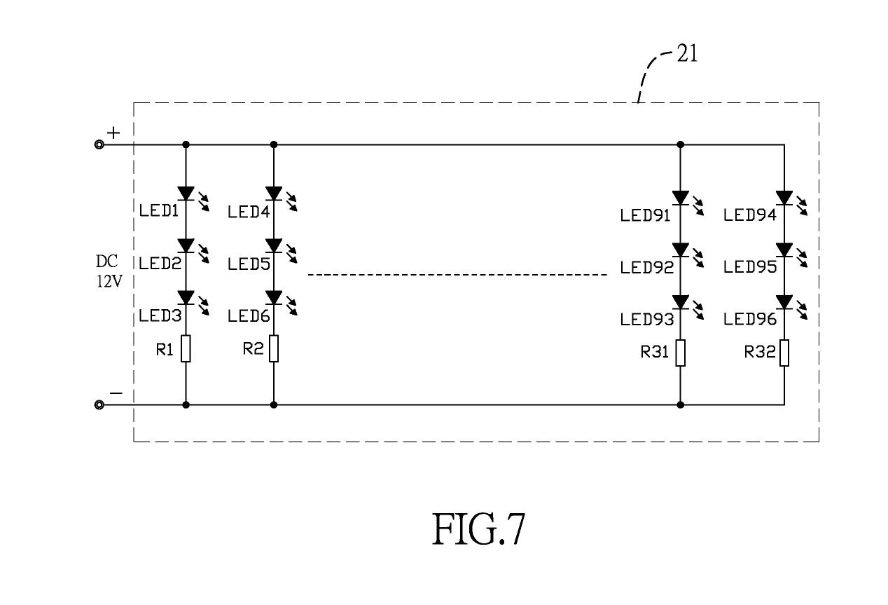

With reference to FIG. 7, the AC flexible LED light string operated in the normally-lighting mode can be implemented by this circuit diagram. The LEDs on the at least one light strip 20 are connected in series to form multiple branches, and all the branches are connected in parallel. The power control assembly 10 provides the DV voltage 12V to activate the LEDs.

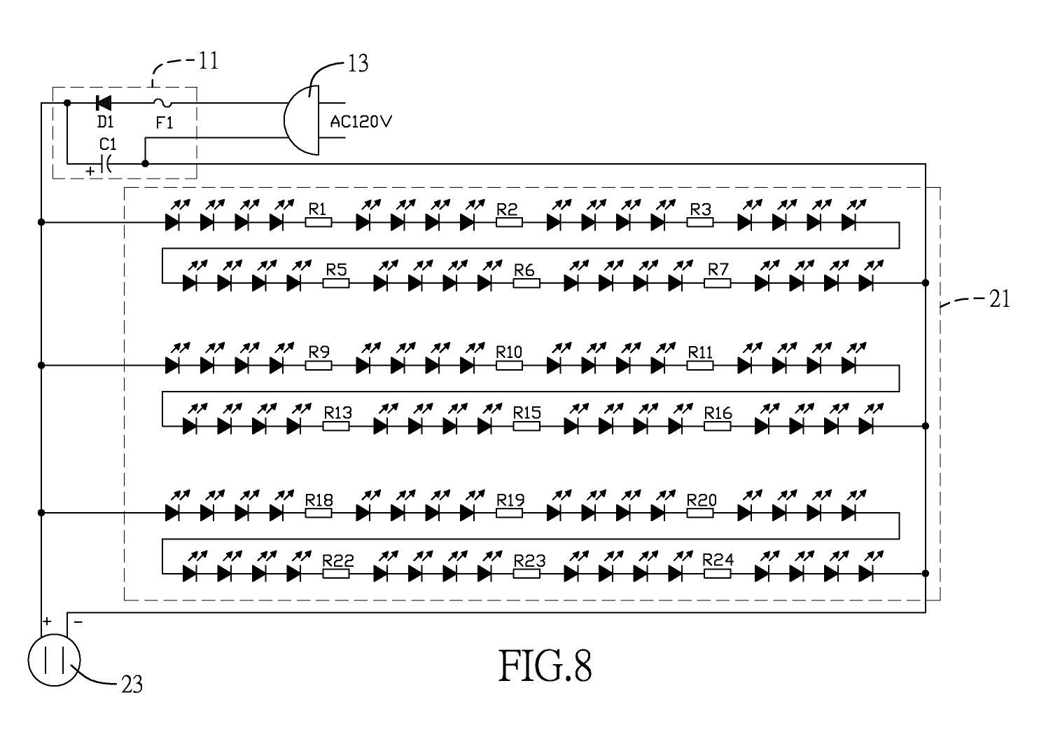

With reference to FIG. 8, this circuit diagram is directed to the AC flexible LED light string of FIG. 4. The power control assembly 10 converts the AC voltage to a half wave DC voltage for driving the LEDs.

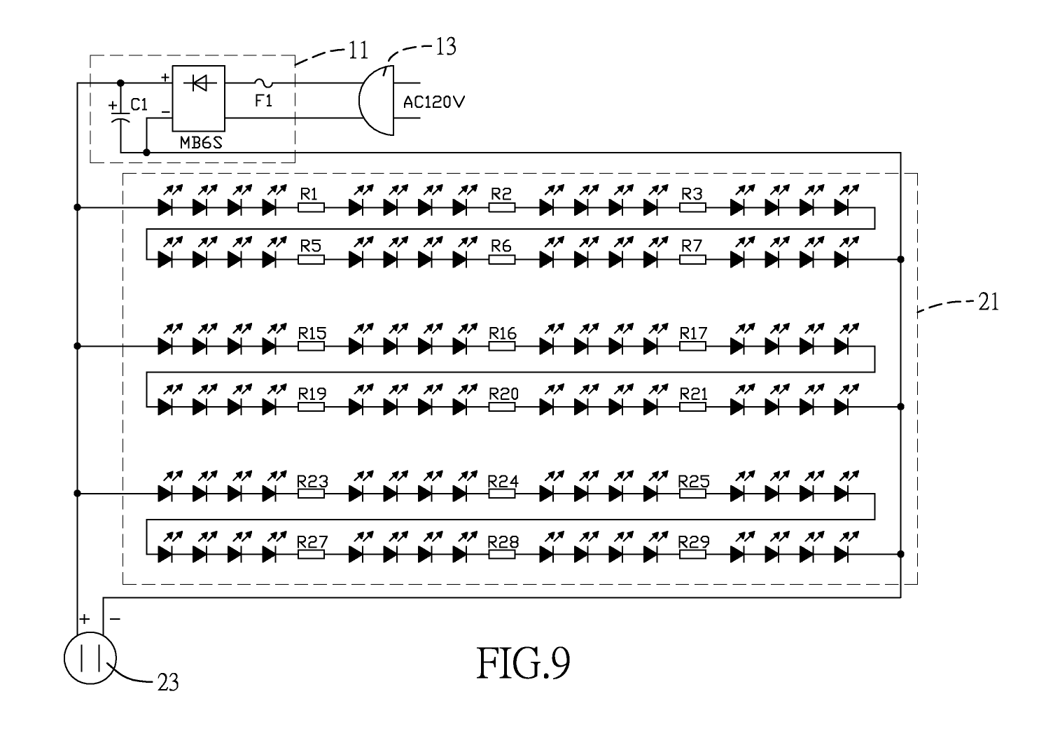

With reference to FIG. 9, this circuit diagram is directed to the AC flexible LED light string operated in the self-flashing mode or the self-color-changing mode. The power converter 11 comprises a full bridge rectifier to convert the AC voltage received to a full wave DC voltage for driving the LEDs.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flexible LED light string comprising:
a power control assembly comprising:
a plug;
a power converter connected to the plug and outputting a DC voltage; and
a main connector connected to the power converter for transmitting the DC voltage;
at least one light strip each comprising:
a body having a first end and a second end, and including a flexible circuit board, multiple LEDs mounted on the flexible circuit board, and a light-pervious protection tube mounted around the flexible circuit board;
a front connector assembled to the first end of the body and detachably screwed to the main connector of the power control assembly and receiving the DC voltage through the main connector; and
a rear connector assembled to the second end of the body for screwing to another subsequent light strip.

2. The flexible LED light string as claimed in claim 1, wherein the power control assembly further comprises a control box connected between the main connector and the power converter.

3. The flexible LED light string as claimed in claim 1, wherein the power control assembly further comprises at least one control button.

4. The flexible LED light string as claimed in claim 1, wherein the plug and the power converter are integrated as a DC power plug.

5. The flexible LED light string as claimed in claim 2, wherein the plug and the power converter are integrated as a DC power plug.

6. The flexible LED light string as claimed in claim 3, wherein the plug and the power converter are integrated as a DC power plug.

7. The flexible LED light string as claimed in claim 1, wherein the main connector has a threaded outer surface and two terminal holes;
the front connector has a threaded inner surface correspondingly screwed to the threaded outer surface of the main connector and has two signal terminals inserted and electrically connected to the terminal holes of the main connector; and
the rear connector has a threaded outer surface and two terminal holes.

8. The flexible LED light string as claimed in claim 2, wherein the main connector has a threaded outer surface and two terminal holes;
the front connector has a threaded inner surface correspondingly screwed to the threaded outer surface of the main connector and has two signal terminals inserted and electrically connected to the terminal holes of the main connector; and
the rear connector has a threaded outer surface and two terminal holes.

9. The flexible LED light string as claimed in claim 3, wherein the main connector has a threaded outer surface and two terminal holes;
the front connector has a threaded inner surface correspondingly screwed to the threaded outer surface of the main connector and has two signal terminals inserted and electrically connected to the terminal holes of the main connector; and
the rear connector has a threaded outer surface and two terminal holes.

10. The flexible LED light string as claimed in claim 4, wherein the main connector has a threaded outer surface and two terminal holes;
the front connector has a threaded inner surface correspondingly screwed to the threaded outer surface of the main connector and has two signal terminals inserted and electrically connected to the terminal holes of the main connector; and
the rear connector has a threaded outer surface and two terminal holes.

11. The flexible LED light string as claimed in claim 5, wherein the main connector has a threaded outer surface and two terminal holes;
the front connector has a threaded inner surface correspondingly screwed to the threaded outer surface of the main connector and has two signal terminals inserted and electrically connected to the terminal holes of the main connector; and
the rear connector has a threaded outer surface and two terminal holes.

12. The flexible LED light string as claimed in claim 6, wherein the main connector has a threaded outer surface and two terminal holes;
the front connector has a threaded inner surface correspondingly screwed to the threaded outer surface of the main connector and has two signal terminals inserted and electrically connected to the terminal holes of the main connector; and
the rear connector has a threaded outer surface and two terminal holes.

13. The flexible LED light string as claimed in claim 10, wherein a sealing lid is mounted to the rear connector of a last one of the at least one light strip; and a first waterproof washer is mounted between the sealing lid and the rear connector.

14. The flexible LED light string as claimed in claim 11, wherein a sealing lid is mounted to the rear connector of a last one of the at least one light strip; and a first waterproof washer is mounted between the sealing lid and the rear connector.

15. The flexible LED light string as claimed in claim 12, wherein a sealing lid is mounted to the rear connector of a last one of the at least one light strip; and a first waterproof washer is mounted between the sealing lid and the rear connector.

16. The flexible LED light string as claimed in claim 10, wherein a second waterproof washer is mounted between the main connector and the front connector.

17. The flexible LED light string as claimed in claim 11, wherein a second waterproof washer is mounted between the main connector and the front connector.

18. The flexible LED light string as claimed in claim 12, wherein a second waterproof washer is mounted between the main connector and the front connector.
